(19) United States
(12) Patent Application Publication
(10) Pub. No.: US 2025/0213956 A1
(43) Pub. Date: Jul. 3, 2025

(54) REAL-TIME SCORING DEVICE, METHOD, AND APPLICATION PROGRAMMING INTERFACE

(71) Applicant: Katherine M. MELTON, Rochester, NY (US)

(72) Inventor: Katherine M. MELTON, Rochester, NY (US)

(21) Appl. No.: 18/948,683

(22) Filed: Nov. 15, 2024

Related U.S. Application Data
(60) Provisional application No. 63/603,901, filed on Nov. 29, 2023.

(51) Int. Cl. A63B 71/06; G10L 17/22

(52) U.S. Cl. CPC A63B 71/0669; G10L 17/22

(57) ABSTRACT

A computer-implemented method and scoring apparatus are disclosed and the method include program code executing on one or more processors receiving a command to initiate scoring of a game and identifying that users are engaged in the game based on obtaining vocal identifiers from each user of the users. The program code continuously determines a score for the game based on obtaining vocal commands from user and displays the score on a visual interface.

### CROSS-REFERENCE TO RELATED APPLICATION

This application claims priority from U.S. Provisional Application No. 63/603,901 filed Nov. 23, 2023, entitled, “REAL-TIME SCORING DEVICE, METHOD, AND APPLICATION PROGRAMMING INTERFACE”, which is incorporated herein by reference, in its entirety, for all purposes.

### BACKGROUND

The present invention relates generally to an automated real-time scoring apparatus and method that can be utilized, specifically, to score various games, including but not limited to court games, such as tennis, and course games, such as golf.

Artificial intelligence (AI) refers to intelligence exhibited by machines Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

There are various sports in which players are relied upon to keep score accurately and to self-report other events that occur during game play. For example, in the world of racket sports where you keep your own score, unless you're a pro-tour player, there is the challenge to keep the score accurate and in real-time without the disruption to the flow of match play. With a multitude of distractions that can naturally occur during a match or during a game, it becomes easy for players to lose recollection of the score causing frustration.

### SUMMARY

Shortcomings of the prior art are overcome, and additional advantages are provided through the provision of a computer-implemented method for scoring a game. The method can include: obtaining, by one or more processors of a scoring device, via one or more receivers, a command to initiate scoring of a game; identifying, by the one or more processors, users engaged in the game based on obtaining vocal identifiers from each user of the users; continuously determining, by the one or more processors, a score for the game based on obtaining vocal commands from user; and displaying, by the one or more processors, the score on a visual interface.

Shortcomings of the prior art are overcome, and additional advantages are provided through the provision of a computer program product for scoring a game. The computer program product comprises a storage medium readable by one or more processors and storing instructions for execution by the one or more processors for performing a method. The method includes, for instance: obtaining, by the one or more processors of a scoring device, via one or more receivers, a command to initiate scoring of a game; identifying, by the one or more processors, users engaged in the game based on obtaining vocal identifiers from each user of the users; continuously determining, by the one or more processors, a score for the game based on obtaining vocal commands from user; and displaying, by the one or more processors, the score on a visual interface.

Shortcomings of the prior art are overcome, and additional advantages are provided through the provision of a system for scoring a game. The system includes: a memory, one of more processors in communication with the memory, and program instructions executable by the one or more processors via the memory to perform a method. The method includes, for instance: obtaining, by the one or more processors of a scoring device, via one or more receivers, a command to initiate scoring of a game; identifying, by the one or more processors, users engaged in the game based on obtaining vocal identifiers from each user of the users; continuously determining, by the one or more processors, a score for the game based on obtaining vocal commands from user; and displaying, by the one or more processors, the score on a visual interface.

Shortcomings of the prior art are overcome, and additional advantages are provided through the provision of an apparatus for scoring a game, the apparatus comprising a sleeve to accept a post, the sleeve comprising: one or more receivers to obtain sound data from a physical location; a memory; one or more processors in communication with the memory and with the one or more receivers; and program instructions executable by the one or more processors via the memory to perform a method comprising: obtaining, by the one or more processors, via the one or more receivers, a command to initiate scoring of a game, identifying, by the one or more processors, users engaged in the game based on obtaining vocal identifiers from each user of the users, continuously determining, by the one or more processors, a score for the game based on obtaining vocal commands from user; and displaying, by the one or more processors, the score on a visual interface.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts a block diagram that illustrates various aspects of one or more aspects of the present disclosure;

FIG. 2 illustrates aspects of a scoring device utilized in a scoring system disclosed herein;

FIG. 3 illustrates examples of scoring commands and regular match play commands and displays in a database that can be utilized to train program code in some embodiments of the present disclosure;

FIG. 4 illustrates examples of operation commands, commands that instruct a scoring device to where a match is in progress, and commands that instruct a scoring device to set a scoring style in a database that can be utilized to train program code in some embodiments of the present invention;

FIG. 5 illustrates examples of tiebreaker scoring commands in a database that can be utilized to train program code in some embodiments of the present invention;

FIG. 6 illustrates aspects of a scoring device utilized in a scoring system disclosed herein;

FIG. 7 illustrates aspects of a scoring device utilized in a scoring system disclosed herein;

FIG. 8 illustrates aspects of a scoring device utilized in a scoring system disclosed herein;

FIG. 9 illustrates a workflow performed by various aspects of some embodiments described herein;

FIG. 10 illustrates aspects of a mobile computing application that can be included in the scoring systems described herein;

FIG. 11 illustrates aspects of a mobile computing application that can be included in the scoring system described herein;

FIG. 12 illustrates various aspects of some embodiments of the present invention;

FIG. 13 depicts a computer system configured to perform an aspect of an embodiment of the present invention; and

FIG. 14 depicts a computer program product incorporating one or more aspects of the present invention.

### DETAILED DESCRIPTION

Aspects of the present invention and certain features, advantages, and details thereof, are explained more fully below with reference to the non-limiting examples illustrated in the accompanying drawings. Descriptions of well-known materials, fabrication tools, processing techniques, etc., are omitted so as not to unnecessarily obscure the invention in detail. It should be understood, however, that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. The terms software and program code are used interchangeably throughout this application and can refer to logic executed by both hardware and software. Components of the system that can be utilized to execute aspects of embodiments of the present invention may include specialized hardware, including but not limited to, a GPP, an FPGA and a GPU (graphics professor unit). Additionally, items denoted as processors may include hardware and/or software processors or other processing means, including but not limited to a software defined radio and/or custom hardware.

The examples herein comprise a computer-implemented method, a computer system, computer readable media, and an apparatus that comprises program code (executed by one or more processors) that can be utilized for real-time scoring in sports, including but not limited to, racquet sports, by players in a manner that is not disruptive to the flow of match play and does not require human intervention. Described herein are: 1) a physical apparatus that attaches to aspects of courts in racquet sports and comprises one or more processor to execute program code; 2) program code that executes on one or more processors of the physical apparatus to score matches occurring at the courts, in real-time; and 3) an application programming interface (API), accessible via a graphical user interface on a computing device, that can enable the user of the computing device to interact with the program code executing on the device that can interact with the program code executing on the device. These various aspects can be utilized together or separately to improve automated scoring in sports, such as racquet sports. Raquet sports is used throughout as an example of a type of sport in which the aspects disclosed herein would provide a practical application. Raquet sports, including but not limited to, tennis, lend themselves to the disclosures herein because: 1) they take place in an environment configured to play a particular sport (a course, a court, a pitch, etc.); and 2) they rely on self-reporting by players for scoring. For this reason, racquet sports are used as an example throughout this paper. However, as understood by one of skill in the art, aspects of some embodiments of the present invention can be integrated into varying sports and games and environments in which these sports and games are played. As one non-limiting example, some of the examples described herein can be utilized to score a golf game.

The examples herein provide a significant advantage over current scorekeeping systems. Some current systems utilize digital mobile applications and/or a wearable devices, but require the players of the sport to manually the score is manually advanced and thus, are disruptive to the flow of play, increasing the length of the match and thus create a bottleneck at the racquet sports facility. Meanwhile, the examples described herein are automated and convenient and simplify the process of keeping score by combining, in some examples, artificial intelligence (e.g., machine learning), as well as a model trained utilizing a database. By utilizing the examples herein, program code can provide accurate and non-disruptive scoring for matched including, but not limited to, racquet sports, for users that include racket sports enthusiasts, competitive players, casual and recreational players, seniors and retirees and technology adopters. Unlike existing scoring systems, the examples herein are desire for an accurate, convenient, and user friendly and hence, provide significantly more than existing systems because, for example, the program code and/or apparatus described herein provide a scorekeeping solution that enhances enjoyment and engagement in racquet sports.

Embodiments of the present invention are inextricably tied to computing and are directed to a practical application. The examples herein provide a computer-based solution to a known issue in scoring racquet sports and, additionally, some examples provide a custom apparatus that enables effective usage of the program code executed by the apparatus. As will be described in greater detail herein, various embodiments can include a custom apparatus, software that executes on the apparatus that is trained (e.g., using machine learning) utilizing a database, and an API to access one or more of the databases and the scoring application. Users can utilize the API via a personal computing device, including but not limited to a wearable device. Aspects of embodiments of the present invention are inextricably tied to computing at least because they utilize a combination of computer-enables technology that includes, but is not limited to, voice-recognition (cognition), machine learning, and customized (to a specific environment) hardware. These technologies are combined and directed to a practical application, automatically accurately scoring a racquet sports match, in real-time.

The examples herein are directed to a practical application also because they enhance the experience of players and spectators. Having a professional on-court scoring system can validate the experience of playing a sport that encourages players at all levels of athleticism and ability and instills in a player a sense of confidence and drive to be and play at an ability above their standard. For the people who are discovering the experience of competitive sport environments, the examples herein can elevate their experience to a next level, whether it's a match with friends or a local competition. Accurate scoring improved the quality of the game. Spectators also benefit from this new technology. They can download the app on their mobile device, or smart watch to enjoy real-time scoring without having to be standing at courtside to bear the score As will be explained herein, in some examples, the program code of the scoring device is configured to display the score on a smart TV in broadcast view where spectators sit while watching the match. The examples herein provide a convenience not only for the players and spectators but also for the facilities who host the matches.

Some embodiments of the present invention include: 1) a scoring device (positioned in the physical environment where a match will be played); 2) program code executing on the scoring device (e.g., one or more processors), and 3) an API accessible via a mobile computing device (e.g., a smart watch worn by a player). The program code which is executed by the scoring device and the mobile computing device can be accessed by one or more devices in a memory in a distributed computing system, including but not limited to a cloud computing system, or can be stored locally on memories integrated in the scoring device and/or the mobile device.

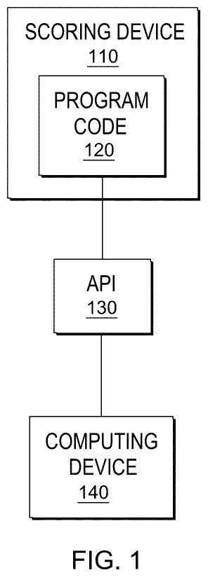

FIG. 1 is a diagram that provides an overview of a scoring system 100 (e.g., a voice activated real-time scorekeeper, which is self-directed and hands-free) into which aspects of the present invention can be integrated. In this example, the system 100 includes the scoring device 110, the program code 120 executing on the scoring device 110, an API 130 in communication with the scoring device 110 (and/or specifically with the program code 120 or one or more processors executing the program code), and a mobile computing device 140, for displaying the scoring to a user and enabling a user to communicate with the scoring system. The API can also be understood as a mobile application. As is illustrated herein, the scoring device 110 is a portable on-court hardware device that can operate in conjunction with a companion mobile software application (e.g., API in communication with the scoring device 130) for players to use on a smart watch (e.g., a mobile computing device 140) during match play. The (physical) scoring device 110 can be fixed to an object on a court or other environment in which a sport or game is to be played. In some examples, the scoring device 110 can be FCC certified and both weather and shock resistant. In some examples, the scoring device 110 the device is powered by a USB charge and capable of lasting approximately twelve continuously on a single charge. As understood by one of skill in the art, other means of (mobile) power sources can be substituted in various examples.

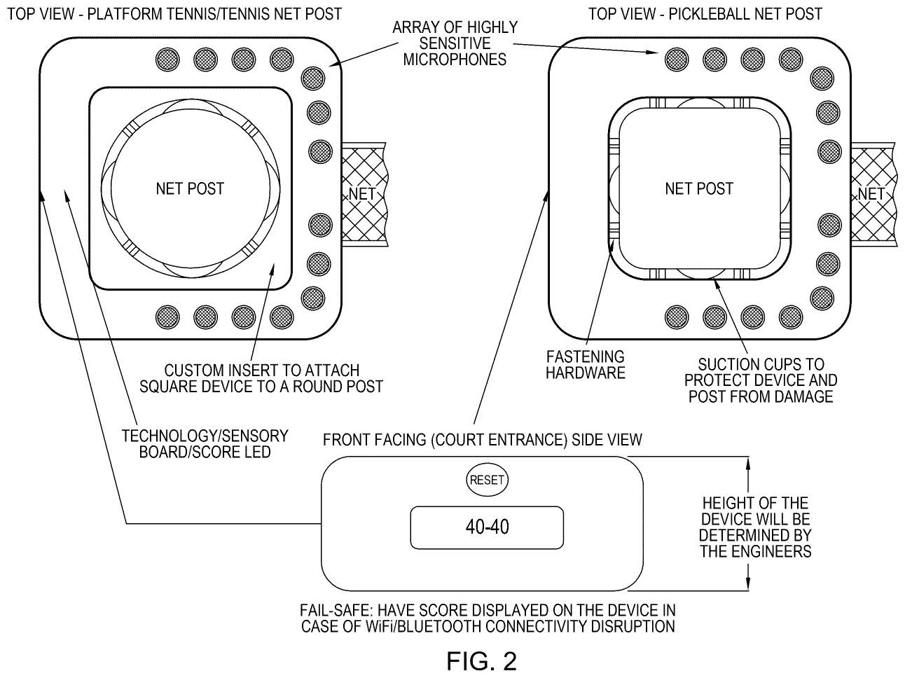

FIG. 2 illustrates the scoring device 110 utilized in various examples herein. The scoring device 110 comprises custom hardware selected for its form as well as its durability. As will be discussed herein, the scoring device 110 can include one or more processors (or can remotely access one or more processors) to execute program code that is trained based on an updateable database of scoring commands. The example of the scoring device 110 in FIG. 2 is configured to fit around a portion of a post and thus, can be used to score a court game. Both an example that can be utilized on a tennis court and one that can be utilized on a pickleball court are provided. In addition to hardware/software elements (one or more processors to execute program code), the scoring device casing attaches around a net port. In this non-limiting example, the device includes sound receivers (e.g., an array of microphones) and a scoreboard (e.g., LED scoreboard), around the outer perimeter. A custom insert attaches the (in this non-limiting example) square scoring device to the net post. Both fastening hardware and suction cups can be used to attach the device to the post as well as to prevent any damage to the post.

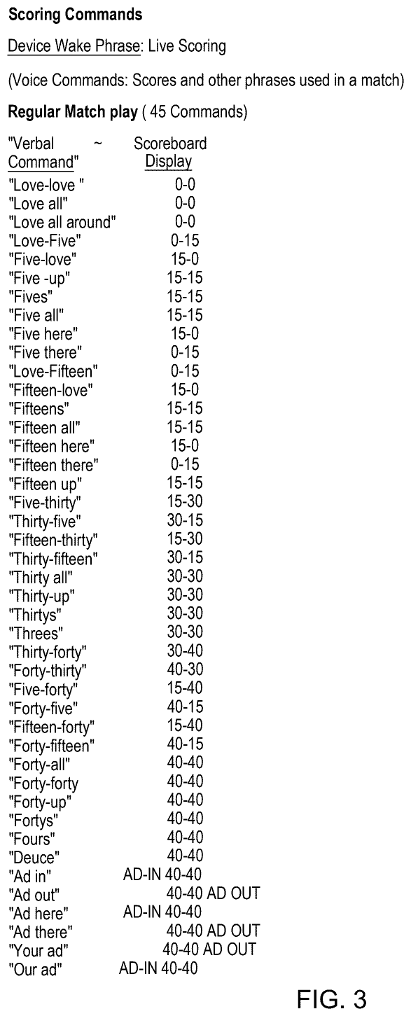

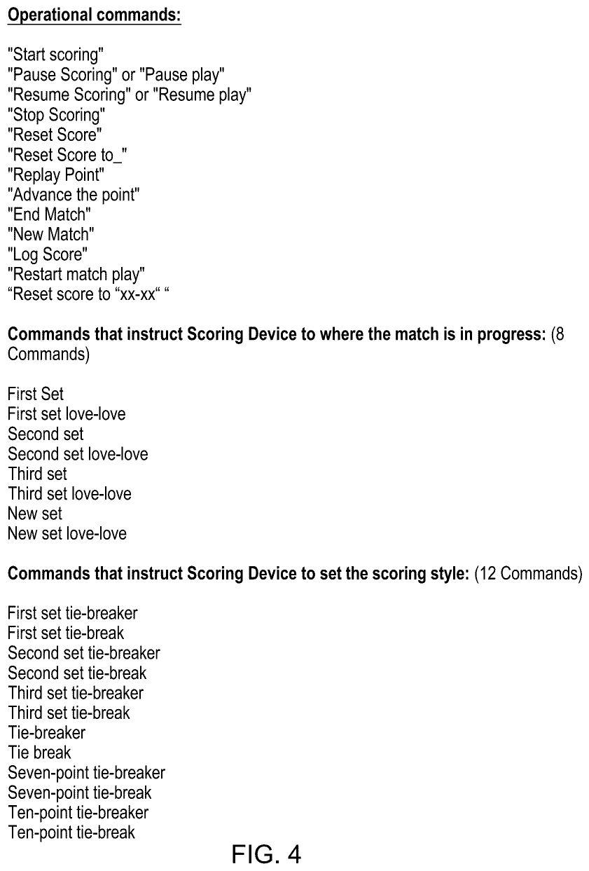

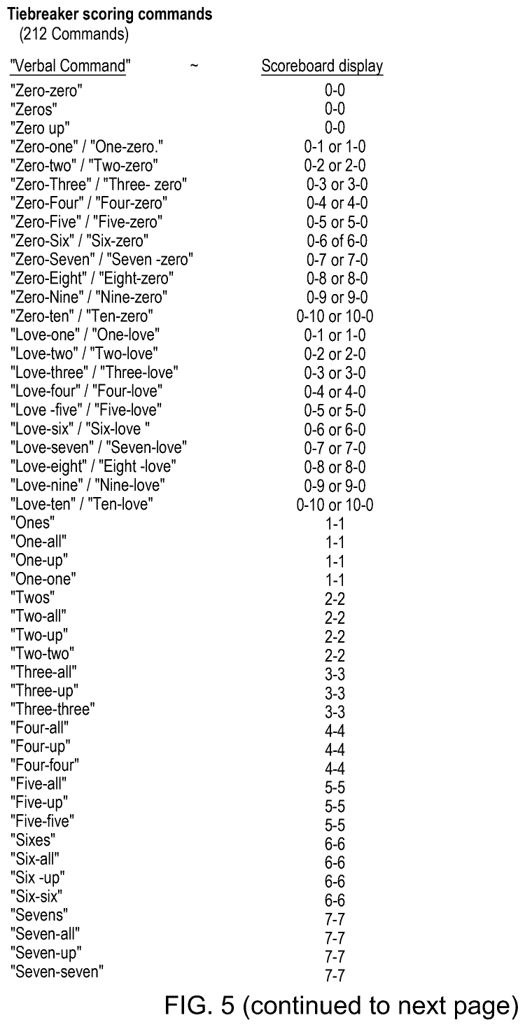

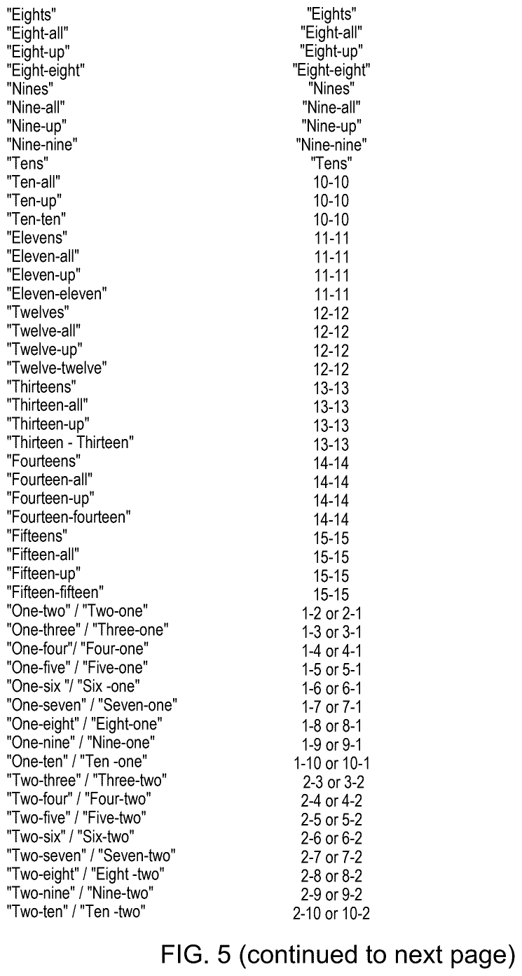

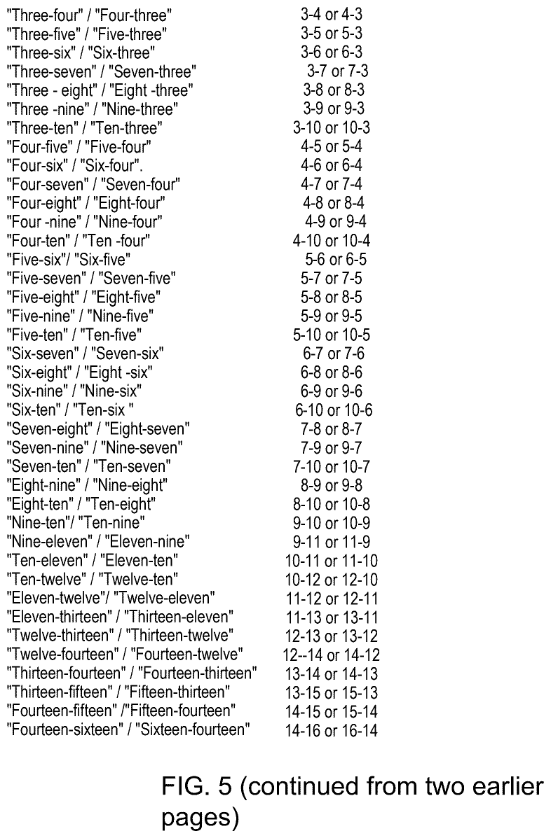

FIGS. 3-5 are an example of scoring commands that can be utilized to train the program code executing on the scoring device 110 such that the scoring device can keep score of actions on the court (or other sporting venue (e.g., course, pitch)) based on vocalizations of the actions on the court. The program code executed in the scoring device 110 includes voice recognition software. The voice recognition software can be customized and/or an existing voice recognition API can be integrated into the scoring device 110, to work in contrast with one or more receiver (receivers can be integrated into the scoring device 110, positioned at various locations on the court, and/or the program code can obtain voice data from existing receiver in a mobile device worn by one or more players which communicates with the scoring device 110, including via the aforementioned API 130.

Referring to FIG. 2, a scoring device (e.g., FIG. 1, 110) can be securely attached to a court's net post prior to match play. To activate the device (automatically), a user can speak a wake command (e.g., a specific verbal command), which is obtained by the program code via the aforementioned receivers. The users (e.g., players) can then configure the device for use for the specific match utilizing verbal command to record their names, and as such, their voices. The program code retains vocal recognition data and associates each voice with each named user (player) prior to the commencement of match play. In this way, the program code can determine which player speaks which commands (words that the program code was trained to understand as scoring data) during the match. The program code executing on the scoring device 110, via the receivers (and upon applying one or more voice recognition and/or cognition API) will receive vocal information throughout the match as it is proper etiquette and part of the game, to speak aloud the score upon serving so that all players know what the score is.

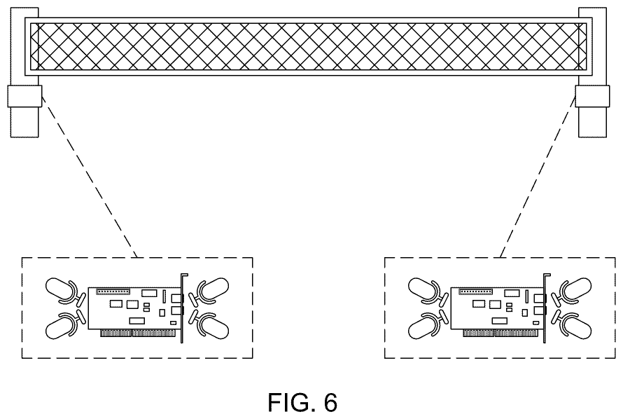

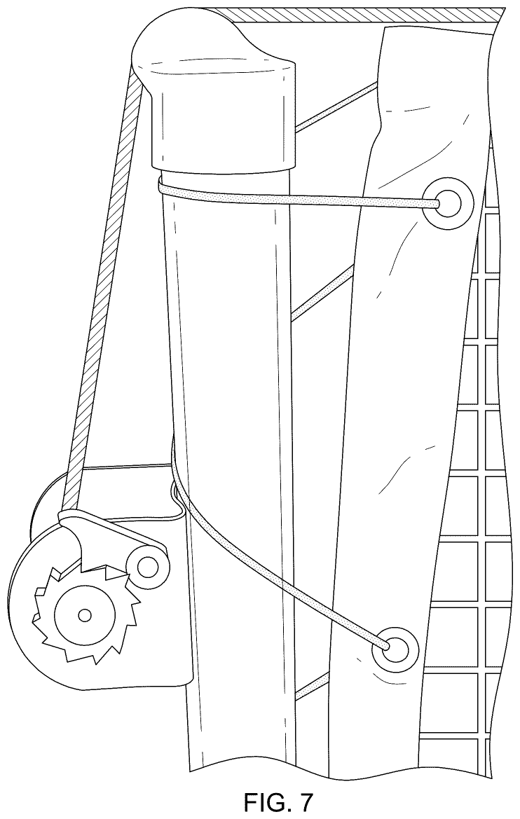

Referring to FIG. 2, in some examples of the scoring device, the (sound) receivers comprise a sensory board with the software technology and an array of highly sensitive microphones that are designed to “listen” for the verbal speech command or score (speech recognition) that has been pre-programmed into the device/application and spoken aloud from the player upon serving These commands include various ways in which the score is spoken, including the vernacular, as well as operational commands. As aforementioned, FIGS. 3-5 are an example of possible vocabulary (e.g., database of terms) to utilize in training the program code to match scoring to sound data (interpreted by the voice recognition functionality, which can include an API). Depending on the sport as well as the language in which the sport is played, one could update the database of terms (including through use of the aforementioned mobile application) to train the program code to recognize additional scoring terms. FIG. 6 illustrates a possible placement of the scoring device on posts of a court. FIG. 7 also illustrates the scoring device 110 (e.g., FIG. 1), as attached to a post on a court.

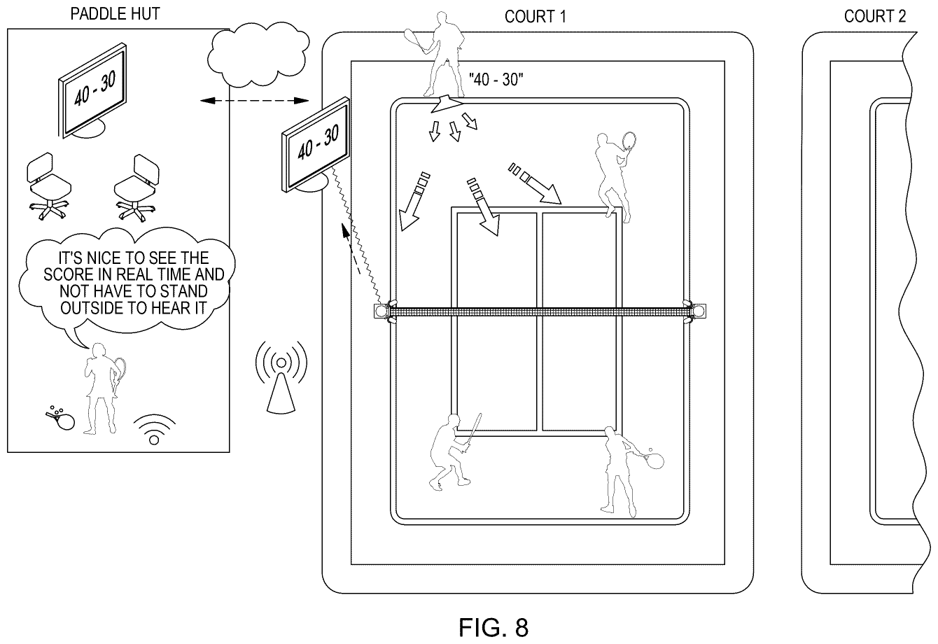

FIG. 8 is an illustration of scoring device (e.g., FIG. 1, 110) in use on a tennis court. In this illustration. The scoring device is communicatively coupled to one or more monitors (e.g., interface) that display the score produced (and updated) by the device. One monitor is visible to the players engaged in the game (on the court) while the other is resident in a weather safe area (paddle but) so that an observer can enjoy the game and see the score without engaging with the weather elements on an exposed court. The receivers that obtain sound from the players (as they recite various scoring terms learned by the program code) are illustrated (not to scale) affixed to the posts of the net (with one or more physical scoring device, which share data between them).

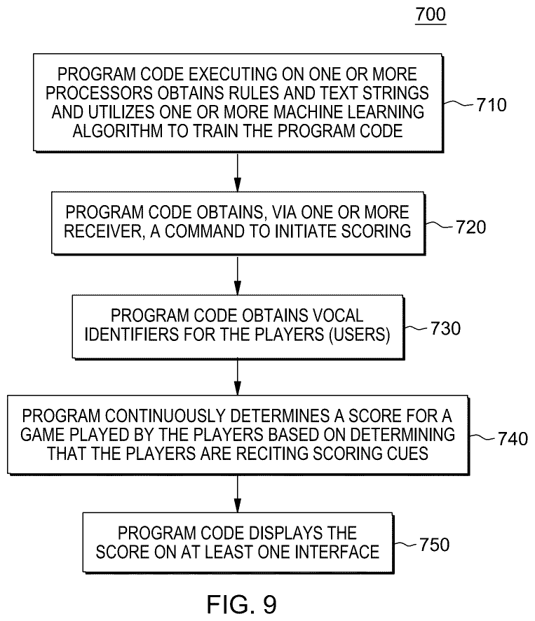

FIG. 9 is a workflow 700 that illustrates various aspects of some examples herein. As illustrated in FIG. 9, program code executing on one or more processors (of a scoring device at a sporting venue) obtains rules and text strings (as will be provided during a game by voice recognition and cognition software) and utilizes one or more machine learning algorithm to train the program code (710). The program code obtains, via one or more receiver (which can be integrated into a scoring device and/or otherwise positioned in the sporting venue and communicatively coupled to one or more processors in the scoring device), a command to initiate scoring (720). The program code obtains vocal identifiers for the players (users) (730). The program continuously determines a score for a game played by the players based on determining that the players are reciting scoring cues (740). The program code displays the score on at least one interface (750). The program code can stop scoring either based on determining that the game has ended (e.g., based on the score) or based on obtaining a vocal command to stop scoring.

Program code executing on the scoring device is configured with rules of the game, including how the game is scored. This logic layer provides the program code with an ability to interpret the data provided through vocal recognition in the context of the game and to match the sound data with the terms in the context of the game. Thus, the scoring is logical and errors in interpretation can be minimized based on the logic framework. In practice, in some examples, once the program code obtains a verbal signal (score), the program code executing on the device can recognize the player's voice (voice recognition) and will interpret which player is serving, thus able to identify the player/team and to whom to award the point. The voice recognition of the examples herein can assist in preventing cross contamination with another device on an adjacent court. The program code executing on the scoring device can distinguish who is speaking and thus will award points when an expected individual recites a score or other action which would create a scoring update, based on the logic layer.

Although, as illustrated in FIGS. 3-5, the scoring device can provide a score itself, the program code executing on the scoring device can also provide the score via mobile devices worn or otherwise associated with the users (players). In some configurations, program code executing on the mobile devices can utilize an API to access the scoring by the scoring device. In other examples, the program code of the scoring device can communicate (e.g., via Wi-Fi, Bluetooth, etc.), the score to the devices and program code executing on the device, in a messenger application between the devices, or at the mobile device, can generate a visual of the score on the personal mobile devices (in a GUI). However, as experienced by the user, upon receiving the verbal signal (score), the program code executing on the device can interpolate the data received and display a numerical score, in real time or near real time, on a companion smart phone/tablet/watch mobile application, and/or using the app on any smart TV in broadcast view.

In some examples, a player can utilize a mobile application (on his or her personal device) to connect to the application (of the scoring device (wirelessly through Bluetooth technology. Thus, a player will never lose their place in the score and won't have to disrupt their match to manually advance it. Additionally, the score can be displayed on the device itself in the event that there is disruption to Wi-Fi/Bluetooth connectivity, providing a medium for viewing a score at all times during the match.

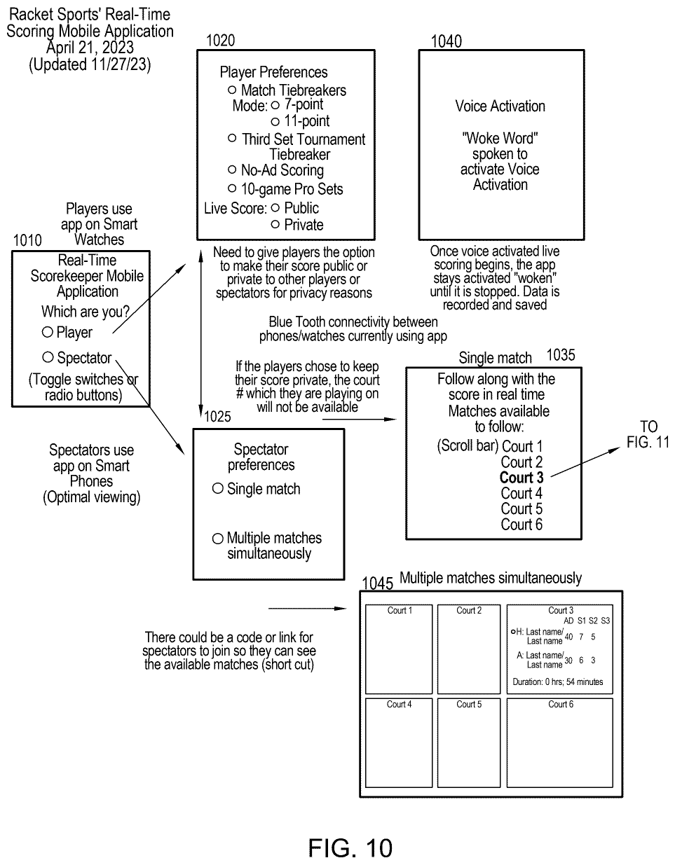

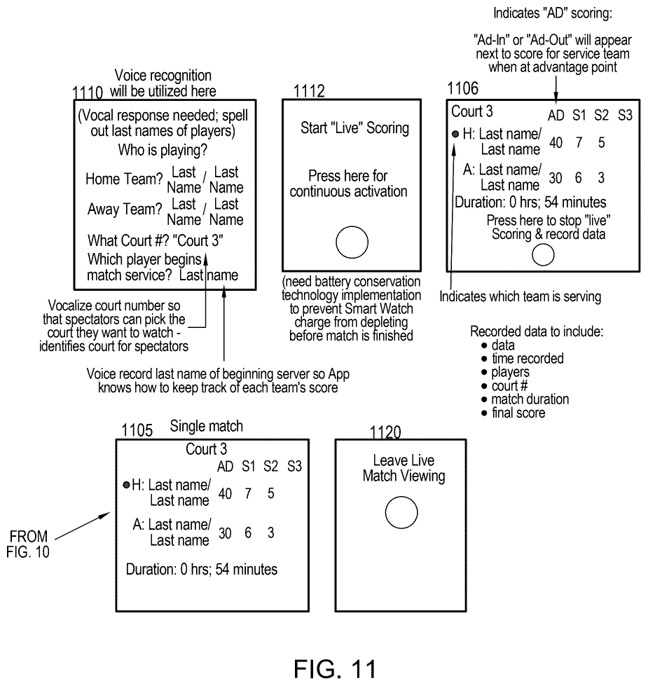

FIGS. 10-11 illustrate a workflow and various visuals in the mobile application that can be available on personal devices utilized by players and/or spectators. FIG. 10 shows certain general displays that a user who is a spectator or a player can interact with while FIG. 11 shows options available on a single court (the match having been selected in a screen displayed in FIG. 10).

In FIG. 10, an initial screen 1010 is used by players or spectators (e.g., on a smart watch or smart phone), to designate whether the user is a player or a spectator. Depending, on the selection, a player preference display 1020 or a spectator preference display 1025 is provided. When a spectator selects a single match, a single match selection display 1035 is generated by the program code so the spectator user can select a court (e.g., selecting Court 3 moves the example to FIG. 11) A player is provided with (by the program code) a player preference display 1020 and can select different preferences, as illustrated in FIG. 10 (e.g., tournament, match tiebreakers, etc.). A spectator can also choose multiple simultaneous matches and view statistics and scores from these matches, as illustrated in the multiple match view 1045. As noted in the player options, voice activation 1040, once a wake word is spoken, the program code commences scoring.

FIG. 11 illustrates particulars of scoring a single match 1105, the Court 3 match selection of FIG. 10. Features illustrated include voice recognition 1110, leaving 1120 live viewing 1120, starting the streaming 1112, and the single match 1106 screen (as see as single match 1105) with some additional descriptions.

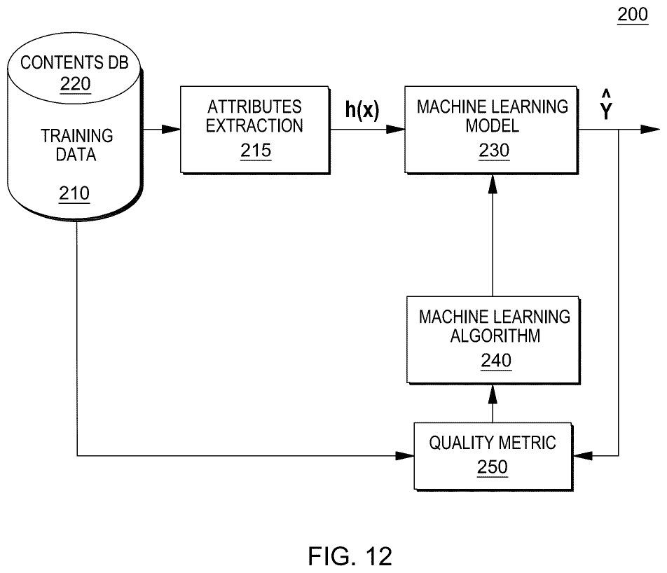

FIG. 12 is an example of a machine learning training system 200 that can be utilized to perform cognitive analyses of data sets provided (including FIGS. 3-5) to generate scoring rules that the program code can utilize to score a game. Program code can obtain data in embodiments of the present invention from a given file, but it can also obtain data from one of more personal devices (e.g., IoT devices, sensors, personal health trackers, physical activity trackers, smart watches, etc.), which the user can be utilizing while playing a game that the program code is later going to score.

Machine learning (ML) solves problems that cannot be solved by numerical means alone. In this ML-based example, program code extracts various features/attributes from training data 210 (e.g., FIGS. 3-5), which can be resident in one or more databases. The data are utilized to develop a predictor function, h (x), also referred to as a hypothesis, which the program code utilizes as a machine learning model 230. In identifying various features/attributes (e.g., patterns) in the training data 240, the program code can utilize various techniques including, but not limited to, mutual information, which is an example of a method that can be utilized to identify features (scoring rules and terms) in an embodiment of the present invention. Further embodiments of the present invention utilize varying techniques to select features (elements, patterns, attributes, etc.), including but not limited to, diffusion mapping, principal component analysis, recursive feature elimination (a brute force approach to selecting features), and/or a Random Forest, to select the features. The program code can utilize a machine learning algorithm 240 to train the machine learning model 230 (e.g., the algorithms utilized by the program code), including providing weights for the conclusions, so that the program code can prioritize various statements in accordance with the predictor functions that comprise the machine learning model 230. The conclusions can be evaluated by a quality metric 250. By selecting a diverse set of training data 210, the program code trains the machine learning model 230 to identify scoring cues and understand the game being played.

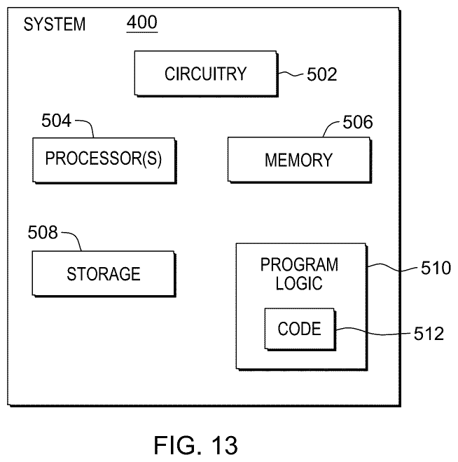

FIG. 13 illustrates a block diagram of a resource 400 in computer system, such as, which is part of the technical architecture of certain embodiments of the technique. Returning to FIG. 13, the resource 400 may include a circuitry 502 that may in certain embodiments include a microprocessor 504. The computer system 400 may also include a memory 506 (e.g., a volatile memory device), and storage 508. The storage 508 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 508 may comprise an internal storage device, an attached storage device and/or a network accessible storage device. The system 400 may include a program logic 510 including code 512 that may be loaded into the memory 506 and executed by the microprocessor 504 or circuitry 502.

In certain embodiments, the program logic 510 including code 512 may be stored in the storage 508, or memory 506. In certain other embodiments, the program logic 510 may be implemented in the circuitry 502. Therefore, while FIG. 13 shows the program logic 510 separately from the other elements, the program logic 510 may be implemented in the memory 506 and/or the circuitry 502. The program logic 510 may include the program code discussed in this disclosure that facilitates the reconfiguration of elements of various computer networks, including those in various figures.

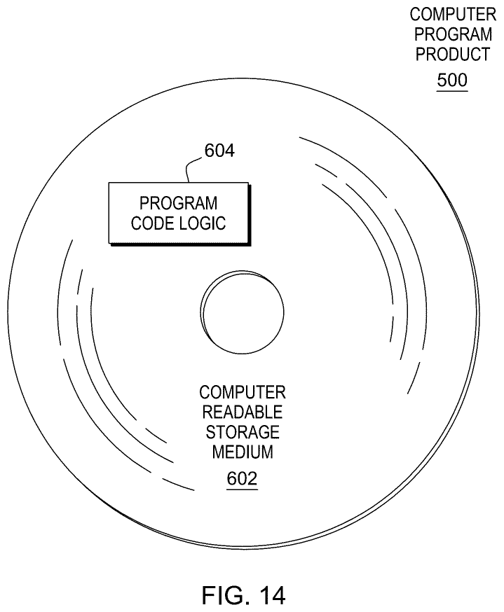

Using the processing resources of a resource 400 to execute software, computer-readable code or instructions, does not limit where this code can be stored. Referring to FIG. 14, in one example, a computer program product 500 includes, for instance, one or more non-transitory computer readable storage media 602 to store computer readable program code means or logic 604 thereon to provide and facilitate one or more aspects of the technique.

As will be appreciated by one skilled in the art, aspects of the technique may be embodied as a system, method or computer program product. Accordingly, aspects of the technique may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the technique may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the technique may be written in any combination of one or more programming languages, including an object oriented programming language, such as Java, Smalltalk, C++ or the like, and conventional procedural programming languages, such as the “C” programming language, PHP, ASP, assembler or similar programming languages, as well as functional programming languages and languages for technical computing (e.g., Python, MATLAB). The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Furthermore, more than one computer can be used for implementing the program code, including, but not limited to, one or more resources in a cloud computing environment.

Aspects of the technique are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions, also referred to as software and/or program code, may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the technique. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition to the above, one or more aspects of the technique may be provided, offered, deployed, managed, serviced, etc. by a service provider who offers management of customer environments. For instance, the service provider can create, maintain, support, etc. computer code and/or a computer infrastructure that performs one or more aspects of the technique for one or more customers. In return, the service provider may receive payment from the customer under a subscription and/or fee agreement, as examples. Additionally or alternatively, the service provider may receive payment from the sale of advertising content to one or more third parties.

In one aspect of the technique, an application may be deployed for performing one or more aspects of the technique. As one example, the deploying of an application comprises providing computer infrastructure operable to perform one or more aspects of the technique.

As a further aspect of the technique, a computing infrastructure may be deployed comprising integrating computer readable code into a computing system, in which the code in combination with the computing system is capable of performing one or more aspects of the technique.

As yet a further aspect of the technique, a process for integrating computing infrastructure comprising integrating computer readable code into a computer system may be provided. The computer system comprises a computer readable medium, in which the computer medium comprises one or more aspects of the technique. The code in combination with the computer system is capable of performing one or more aspects of the technique.

Further, other types of computing environments can benefit from one or more aspects of the technique. As an example, an environment may include an emulator (e.g., software or other emulation mechanisms), in which a particular architecture (including, for instance, instruction execution, architected functions, such as address translation, and architected registers) or a subset thereof is emulated (e.g., on a native computer system having a processor and memory). In such an environment, one or more emulation functions of the emulator can implement one or more aspects of the technique, even though a computer executing the emulator may have a different architecture than the capabilities being emulated. As one example, in emulation mode, the specific instruction or operation being emulated is decoded, and an appropriate emulation function is built to implement the individual instruction or operation.

In an emulation environment, a host computer includes, for instance, a memory to store instructions and data; an instruction fetch unit to fetch instructions from memory and to optionally, provide local buffering for the fetched instruction; an instruction decode unit to receive the fetched instructions and to determine the type of instructions that have been fetched; and an instruction execution unit to execute the instructions. Execution may include loading data into a register from memory; storing data back to memory from a register; or performing some type of arithmetic or logical operation, as determined by the decode unit. In one example, each unit is implemented in software. For instance, the operations being performed by the units are implemented as one or more subroutines within emulator software.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means of steps plus function elements in the descriptions below, if any, are intended to include any structure, material, or act for performing the function in combination with other elements as specifically noted. The description of the technique has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular uses contemplated.

Various aspects and embodiments are described herein. Further, many variations are possible without departing from the spirit of aspects of the present disclosure. It should be noted that, unless otherwise inconsistent, each aspect or feature described and/or claimed herein, and variants thereof, may be combinable with any other aspect or feature.

What is claimed is:

1. A computer-implemented method comprising:
obtaining, by one or more processors of a scoring device, via one or more receivers, a command to initiate scoring of a game;
identifying, by the one or more processors, users engaged in the game based on obtaining vocal identifiers from each user of the users;
continuously determining, by the one or more processors, a score for the game based on obtaining vocal commands from user; and
displaying, by the one or more processors, the score on a visual interface.

2. The computer-implemented method of claim 1, further comprising:
training, by the one or more processors, the scoring device to determine the score, the training comprising:
obtaining, by the one or more processors, training data comprising scoring terms and gameplay rules; and
applying, by the one or more processors, one or more machine learning algorithm to determine how to score the game.

3. A scoring apparatus comprising:
a sleeve to accept a post, the sleeve comprising:
one or more receivers to obtain sound data from a physical location;
a memory;
one or more processors in communication with the memory and with the one or more receivers; and
program instructions executable by the one or more processors via the memory to perform a method comprising:
obtaining, by the one or more processors, via the one or more receivers, a command to initiate scoring of a game;
identifying, by the one or more processors, users engaged in the game based on obtaining vocal identifiers from each user of the users;
continuously determining, by the one or more processors, a score for the game based on obtaining vocal commands from user; and
displaying, by the one or more processors, the score on a visual interface.

4. The apparatus of claim 3, the method further comprising:
training, by the one or more processors, the scoring apparatus to determine the score, the training comprising:
obtaining, by the one or more processors, training data comprising scoring terms and gameplay rules; and
applying, by the one or more processors, one or more machine learning algorithm to determine how to score the game.
